(19) United States
(12) Patent Application Publication
(10) Pub. No.: US 2009/0065156 A1
(43) Pub. Date: Mar. 12, 2009

(54) ROLLER SHUTTER

(76) Inventors: William G. Roberts, Beaver Falls, PA (US); Walter W. Stucky, Beaver Falls, PA (US); Kevin A. Seiling, Monaca, PA (US)

Correspondence Address: COHEN & GRIGSBY, P.C., 625 LIBERTY AVENUE, PITTSBURGH, PA, 15222-3152, US

(21) Appl. No.: 11/851,470

(22) Filed: Sep. 7, 2007

(51) Int. Cl. E06B 9/11; E06B 9/56

(52) U.S. Cl. 160/266; 160/290.1; 52/202

(57) ABSTRACT

A roller shutter for protecting doors and windows during high wind conditions wherein a fenestration frame 18 is secured to the header 10 and sill 12 of the building. A spindle 38 is rotatably mounted in a box 28 and one edge of a fabric sheet 40 is attached to the spindle. When the spindle is rotated, the fabric sheet is coiled or uncoiled around the spindle so that the fabric sheet 40 is extended or retracted across the fenestration member.

### BACKGROUND OF THE INVENTION

1. Field of the Invention

The presently disclosed invention concerns mechanisms for protecting windows and doors and, more particularly, shutters for windows and doors.

2. Description of the Prior Art

It has long been recognized that fenestration members such as glass windows and doors are particularly vulnerable to breakage during high winds—particularly during storms such as hurricanes and typhoons in which wind velocities are sufficient to entrain sold objects at relatively high velocity. Under these circumstances, glass in windows and doors is often broken, leaving the building interior exposed to damage from debris and water. Even more potentially hazardous and damaging, such conditions can internally pressurize a house or other building and create a pressure differential great enough to blow off the roof.

Even under circumstances where the glass is not broken, wind loading against the window or door can severely deform the frame so as to allow water to penetrate past the window or door and into the building interior causing substantial damage.

To prevent such damage, it has been a practice for many years to cover fenestration members, particularly glass windows, with protective coverings in advance of high wind conditions. Examples of such protective coverings include steel or aluminum panels, plywood or other hard surfaces that are temporarily secured over the window and then removed after the storm has passed. This protective method has several disadvantages. First, suitable materials for such temporary coverings are sometimes difficult to find or even unavailable at times of peak demand such as in the days or hours before a large storm system arrives in an area. Also, such materials may not be sufficiently strong to withstand high water pressure or impacts from various objects that are projected against them during the storm. Also, installation of such temporary devices requires substantial time and also demands available labor at a time when authorities may be evacuating people from the area.

Prior art devices that have been used to protect windows include accordion shutters that can be unfolded over the window accordion-style, colonial shutters that attach to the wall beside the window, and Bahama shutters that attach above the window. Generally, these shutters can be made storm-ready quickly and easily. However, objections to these devices have included that they can be aesthetically unpleasing, are manually (not remotely) operated, sometimes afford incomplete protection, block too much sunlight during times of non-use, and can't be used to protect doors. Moreover, for aesthetic reasons, local ordinances and property restrictions frequently require that these devices only be deployed at times when a storm is specifically predicted and that they cannot be deployed on a seasonal basis. This is particularly a problem for owners of second homes or vacation houses that are located in hurricane-prone areas.

More recently, other devices have been developed to overcome some of the foregoing disadvantages. Such choices include rigid shutters that are stored in a roll. Such shutters are permanently mounted in a roll over the top of the window and unrolled at times when it is desired to protect the window. These devices generally have performed well in protecting windows. However, because the shutters are composed of a rigid material, they tend to form a relatively bulky roll that is aesthetically unsuitable for some applications.

Other prior art devices include a geosynthetic fabric that is stretched over the window opening such as described in U.S. Pat. No. 6,341,455. These devices are relatively new and have not been accepted in some building codes. Also, installation of such geosynthetic devices have not been deployable by remote means. They have required available labor at a time when authorities are sometimes evacuating people from the area.

Accordingly, there was a need in the prior art for an improved window protection that could be quickly and easily installed with minimal labor requirements and that also would be aesthetically acceptable.

### SUMMARY OF THE INVENTION

In accordance with the subject invention, an aesthetically improved roller shutter assembly is used to cover a fenestration member such as a window or door in a building. The fenestration member is located in a building opening and includes a fenestration frame that is secured to the building frame without a sub-frame therebetween. The fenestration frame has a header that is secured to the header of the building and also has a sill that is secured to the sill of the building. A box is located between the header of the building frame and the header of the fenestration frame and a spindle is rotatably mounted in the box. A fabric sheet has one end that is attached to the spindle so that the fabric sheet coils around the spindle when the spindle is rotated in one direction and uncoils from the spindle when the spindle is rotated in the other direction. By rotating the spindle, the fabric sheet can be extended and retracted over the fenestration member.

Preferably, the roller shutter allows a larger window through the use of a building header that has upper and lower portions that define a space therebetween. The header of the fenestration frame is attached to the lower portion of the building header and the roller shutter box is located in the space that is defined between the upper and lower portions of the building header. In this way, more area is available within the building opening for the fenestration member.

Also preferably, a mechanism is provided to secure the sides of the fabric sheet to the building as well as securing the bottom of the fabric to the building. A group of first retention members such as a solenoid and bracket, a partially closed track, a partially closed channel segment, or a hook are secured to the window casing or window sill trim. A group of second retention members such as a gommet, a bead segment, a button or a hook are secured to the fabric sheet. The first retention members cooperate with the second retention members to secure the sides and the bottom of the fabric sheet and limit bowing of the screen when it is impacted by debris or under heavy wind loading. In this way, the fabric sheet affords effective resistance to impacts and forces against the fenestration member.

In addition, the spindle can be coupled to a motor that can be remotely operated. In this way, the fabric can be extended and retracted by remote commands that activate the motor. Thus, no manual labor is required to deploy the roller shutter.

Also preferably, the fabric sheet is made of a material that is sufficiently flexible that it can be coiled around the spindle, but also strong enough to withstand debris impacts and wind loading under high wind conditions. One material that is preferable for use as the fabric sheet is an aramid fiber composite that is woven into fabric. One example of such fabric is Kevlar™. For certain applications, various woven blends of aramid fibers with other types of fibers are also suitable for use as the fabric sheet. Additionally, the fabric screen can be made of a material that is weatherable and durable under exposure to natural elements including sunlight and water.

To address the difficulty of using a roller shutter in combination with a fenestration unit that has a curved top, the roller shutter box is located at the bottom of the fenestration member and is extended upwardly. The free end of the fabric sheet is contoured to match the curvature of the top of the fenestration member so that the fabric sheet is protective of the fenestration member and also aesthetically acceptable.

Other aesthetic improvements can be realized by adding trim elements to the face of the fenestration member. Such trim elements can be selected from a group of elements that are interchangeable with each other and that have various shapes, surface textures or colors.

Other features, advantages, and objects of the presently disclosed invention will become apparent to those skilled in the art as a description of a presently preferred embodiment thereof proceeds.

### BRIEF DESCRIPTION OF THE DRAWINGS

Presently preferred embodiments of the disclosed invention are shown and described in connection with the accompanying Figures wherein:

FIG. 1 is a vertical cross-section of a window and building that incorporate one embodiment of the disclosed roller shutter:

FIG. 2 is a horizontal cross-section of the window and building incorporating the embodiment of the disclosed roller shutter shown in FIG. 1;

FIG. 3 is a vertical cross-section of a window and building that incorporate another embodiment of the disclosed roller shutter;

FIGS. 4, 5 and 6 are perspective views of a mechanism for securing a fabric sheet as disclosed herein;

FIGS. 7, 7A and 8 are perspective views of an alternative mechanism for secure a fabric sheet as disclosed herein;

FIGS. 9 and 10 are perspective views of another alternative mechanism for securing a fabric sheet as disclosed herein;

FIG. 11 is a partial horizontal cross-section of a window that incorporates another alternative mechanism for securing a fabric sheet as disclosed herein;

FIGS. 12, 13 and 14 are elevation views of another alternative of the roller shutter disclosed herein for use with fenestration members having curved headers;

FIG. 14A is a perspective view of an alternative embodiment for using the roller shutter with fenestration members having curved headers;

FIGS. 15-34 show the exterior portions of the roller shutter that is described herein including ornamental designs thereof; and

FIGS. 35-37 further illustrate designs on the exterior portion of the roller shutter that can be selected from a group of trim components that are interchangeable and that have various textures and colors.

### PREFERRED EMBODIMENT OF THE INVENTION

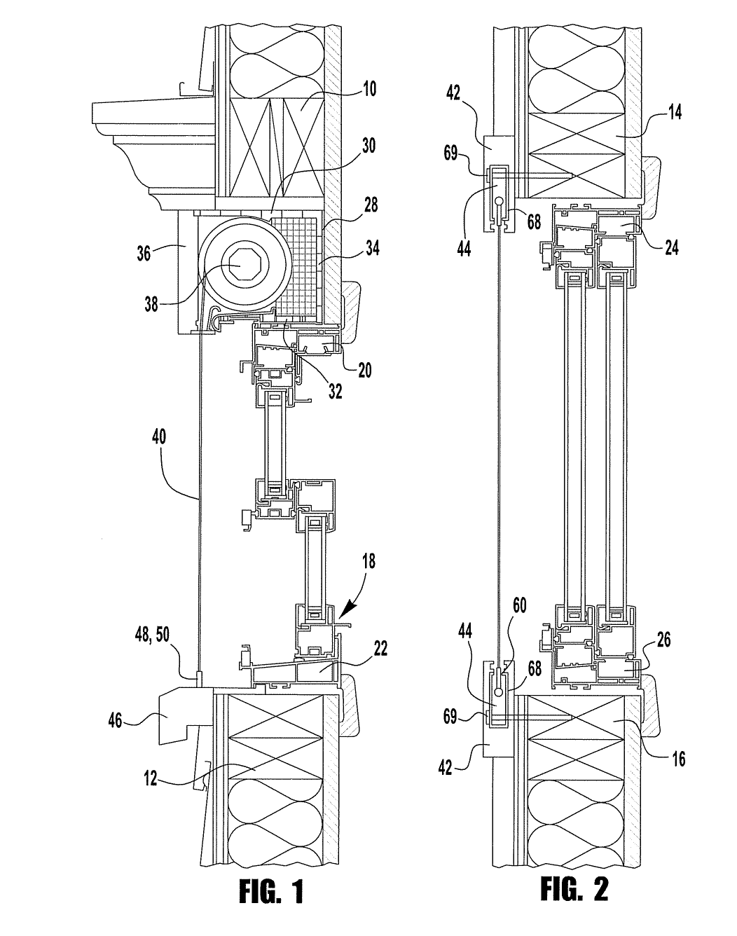

FIGS. 1 and 2 show an embodiment of the presently disclosed invention wherein a roller shutter assembly is used to cover a fenestration member such as a window or a door. As used herein, building openings for fenestration members are referred to generally as fenestration openings in the building. The example of FIGS. 1 and 2 illustrate a fenestration opening that is used for a double hung window. However, doors and other types of windows are also included in the meaning of fenestration member as used herein.

In FIGS. 1 and 2, the fenestration opening is defined by a building frame header 10, a building frame sill 12, a first building frame riser 14 and a second building frame riser 16. One end of first building frame riser 14 is connected a first end of building frame header 10 and the opposite end of building frame riser 14 is connected to a first end of building frame sill 12. One end of second building frame riser 16 is connected to a second end of building frame header 10 and the opposite end of building frame riser 16 is connected to a second end of building frame sill 12.

Also in FIGS. 1 and 2, the roller shutter assembly includes a fenestration frame 18 that includes a fenestration header 20 and a fenestration sill 22. The fenestration frame further includes a first fenestration riser 24 that is connected to a first end of the fenestration header 20 and to a first end of the fenestration sill 22. The fenestration frame also includes a second fenestration riser 26 that is connected to the second end of the fenestration header 20 and to a second end of the fenestration sill 22. In the preferred embodiment, fenestration header 20 and fenestration sill 22 are welded or mechanically fastened to first fenestration riser 24 and second fenestration riser 26.

Many roller shutters that were known in the prior art employed a subframe between the fenestration risers 24 and 26 and the building frame risers 14 and 16. However, the embodiment of FIGS. 1 and 2 uses no subframe. The first fenestration riser 24 is connected directly to the first building frame riser 14 and the second fenestration riser 26 is connected directly to the second building frame riser 16. In this way, a given size of building frame opening can accommodate a larger window than the same frame opening when the fenestration member further includes a subframe.

A box 28 is located between the building frame header 10 and the fenestration frame header 18. Box 28 includes a head 30 and a base 32. Box 28 also includes an interior cover 34 that is connected between an interior edge of head 30 and an interior edge of base 32. In addition, an exterior cover 36 is connected to an exterior edge of head 30. A gap is maintained between the distal edge of cover 36 and the distal edge of base 32. Box 28 further includes end caps that are secured to opposite ends of head 30, base 32, interior cover 34 and exterior cover 38.

A spindle 38 is rotatably mounted in box 28 so that it can be rotated around its longitudinal axis. Spindle 38 can be connected to suitable gearing and a motor that control the turning direction and speed of the spindle 38 in response to electrical command signals. A fabric sheet 40 is connected to spindle 38 at or near one edge of the fabric sheet 40 so that fabric sheet 40 coils around spindle 38 as spindle 38 is rotated in one direction and uncoils from spindle 38 as spindle 38 is rotated in the opposite direction. Spindle 38 is rotated so that fabric sheet 40 is extended and retracted over the opening defined within the fenestration frame 18 in accordance with the angular position of the spindle 38.

In this way, spindle 38 is rotated in one angular direction to extend fabric sheet 40 over the double hung window shown in FIGS. 1 and 2 to protect the window at times when high winds may cause debris to impact the window or may cause water to penetrate past the window into the interior of the building. When normal ambient conditions are reestablished, spindle 38 is rotated in the opposite angular direction to coil the fabric sheet back onto the spindle and retract the fabric sheet from the fenestration opening.

The fabric sheet is made of a material that is sufficiently flexible that it can be coiled around the spindle, but also strong enough to withstand debris impacts and wind loading under high wind conditions. One material that is preferable for use as the fabric sheet is an aramid fiber composite that is woven into fabric. One such fiber known as Kevlar™ is available from DuPont. Various woven blends of aramid fibers with other types of fibers are also suitable for use as fabric sheet 40 under some conditions.

The embodiment of FIGS. 1 and 2 also includes a mechanism for retaining the edges of fabric sheet 40 at times when fabric sheet 40 is extended over the fenestration member. When the edges of fabric sheet 40 are so retained, fabric sheet 40 provides effective resistance to projected debris and wind loading. In the example of FIGS. 1 and 2, a window casing 42 is located on the external wall of the building at the perimeter of the building opening. Window casing 42 defines a fabric track 44. Fabric track 44 is an opening in casing 42 that confines a vertical edge of fabric sheet 40 at times when fabric sheet extends over the fenestration opening.

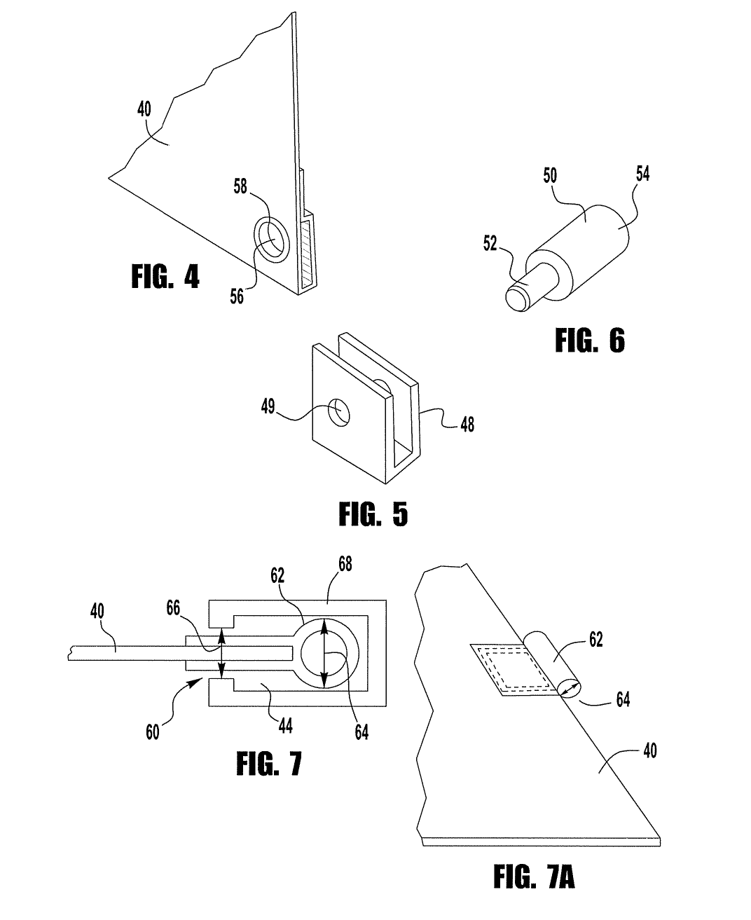

FIGS. 4, 5 and 6 show a retention mechanism for securing the edge of fabric sheet 40 within fabric tracks 44 and also for securing the bottom edge of fabric sheet 40 to a sill trim 46 that is secured to the building frame sill. In FIGS. 4, 5 and 6, a first retention member includes locking brackets 48 having holes 49 are secured to various locations on sill trim 46 and along window casings 42. Each first retention member further includes a solenoid 50 that is associated with each respective locking bracket 48 and are also secured at locations on sill trim 46 and window casings 42 corresponding to locations of the locking brackets 48. Each solenoid 50 has a pin 52 and a coil 54. Pin 52 advances and retracts in response to electrical control signals to coil 54.

Fabric sheet 40 is provided with a second retention member that includes an array of holes 56 that are defined within grommets 58. Holes 56 are located in fabric sheet 40 so that they align with the holes 49 of locking brackets 48 at times when fabric sheet 40 fully covers the fenestration member. With pin 52 retracted into coil 54, fabric sheet 40 is extended over the fenestration opening so that holes 56 are aligned with holes 49 of locking brackets 48. A control signal is then sent to solenoids 50 to cause pin 52 to extend through both holes 56 and 49 and retain the fabric sheet 40. When it is desired to retract fabric sheet 40 from in front of the fenestration member, a control signal is sent to solenoids 50 to cause pins 52 to retract from holes 56 and 49. The edges of fabric sheet 40 are then freed and spindle 38 can be rotated to coil fabric sheet 40 unto spindle 38.

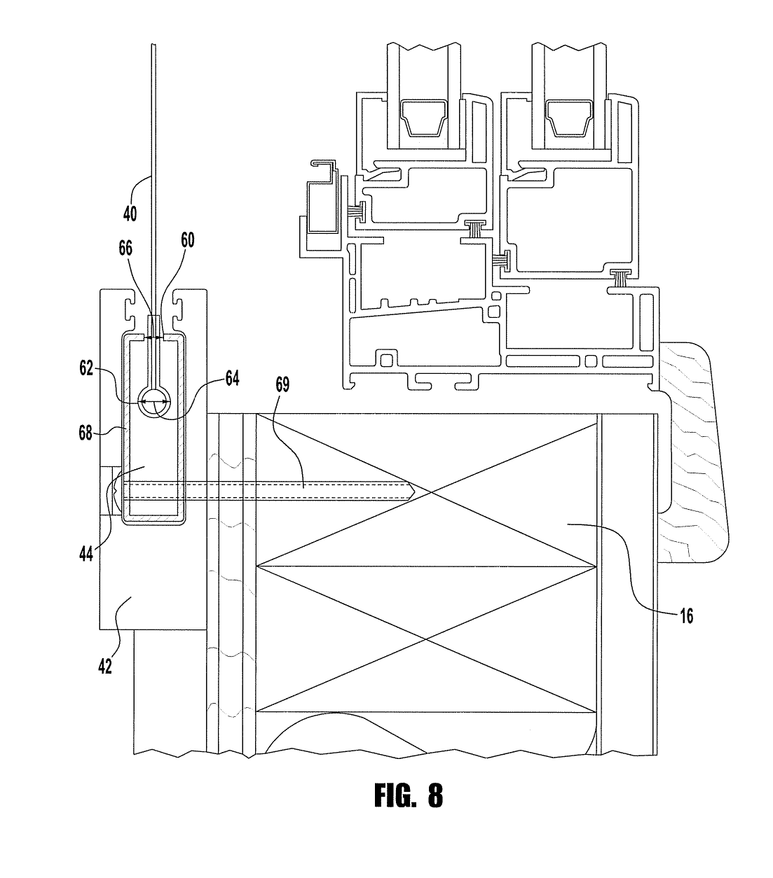

FIGS. 7, 7A and 8 show alternative first and second retention members that can be used to secure the vertical edges of fabric sheet 40 within the fabric track 44 of window casing 42. In the embodiment of FIGS. 7, 7A and 8, the first retention member is in the form of a reinforcing insert 68 that is located in fabric track 44 of casing 42. Reinforcing insert 68 is secured to riser 16 of the building opening by a fastener such as a screw 69. Reinforcing insert 68 defines a restricted neck 60 for fabric track 44. The second retention member is a plurality of bead segments 62 that are sewn to the edge of fabric sheet 40. The bead segments have a diameter 64 that is greater than the gap 66 across the neck 60 of reinforcing insert 68. As fabric sheet 40 is unwound from spindle 38, the bead segments 62 enter and then travel through reinforcing insert 68 and fabric track 44. Because the diameter 64 of bead segments 62 is greater than the gap 66 across the neck 60 of reinforcing insert 68 of fabric track 44, bead segments 62 cannot pass laterally out of fabric track 44 and are retained therein. It is preferred to use bead segments rather than a continuous bead along the edge of fabric sheet 40 because this will allow fabric sheet 40 to be coiled into a smaller diameter coil, thus allowing the use of a box 28 with smaller dimensions that is more easily accommodated within the building opening and that is more aesthetically pleasing.

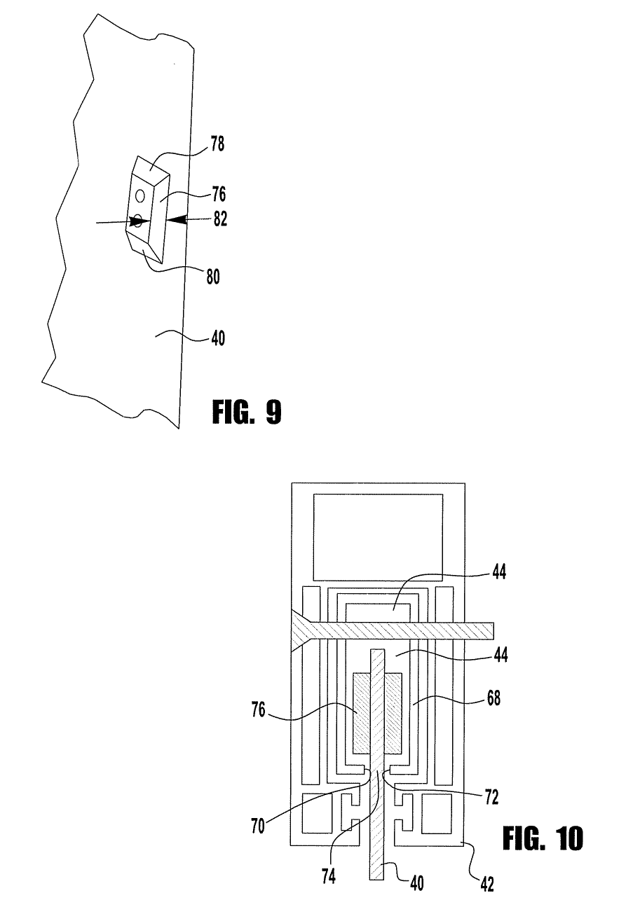

FIGS. 9 and 10 show another alternative first and second retention members that can be used to secure the vertical edges of fabric sheet 40 within the fabric track 44 of window casing 42. In the embodiment of FIGS. 9 and 10, the first retention member is a reinforcing insert 68 that is located in fabric track 44. Reinforcing insert 68 has two edges 70, 72 that define a gap 74 therebetween. The second retention member is a plurality of buttons 76 that are secured to the fabric sheet 40. Buttons 76 have tapered surfaces 78, 80 and a width dimension 82. The width 82 of button 76 is greater than the width of gap 74 defined by edges 70, 72 of reinforcing insert 68.

As fabric sheet 40 is unwound from spindle 38, the buttons 76 enter and then travel through the reinforcing inserts 68 that are located in fabric track 44. Buttons 76 are located on fabric sheet 40 such that they align with respective reinforcing inserts 68 at times when the fabric sheet 40 is fully extended to cover the fenestration member. Because the width 82 of buttons 76 is greater than the gap 74 of reinforcing insert 68, buttons 76 cannot pass laterally out of reinforcing insert 68 and are retained therein.

While uncoiling fabric sheet 40 to cover the fenestration member, buttons 76 that are located toward the free end of fabric sheet 40 have to pass through reinforcing inserts 68 that are associated with buttons 76 that are located closer to spindle 38. Therefore, buttons 76 have tapered surfaces 78, 80 that tend to guide the buttons through reinforcing inserts 68 so that the fabric sheet 40 does not hang up as it is being lowered across or retracted from the fenestration unit.

The use of buttons along the edge of fabric sheet 40 instead of an element that runs continuously along the edge of fabric sheet 40 allows the fabric sheet to be coiled into a smaller diameter coil. This permits the use of a box 28 with smaller dimensions that is more easily accommodated within the building opening and that is more aesthetically pleasing.

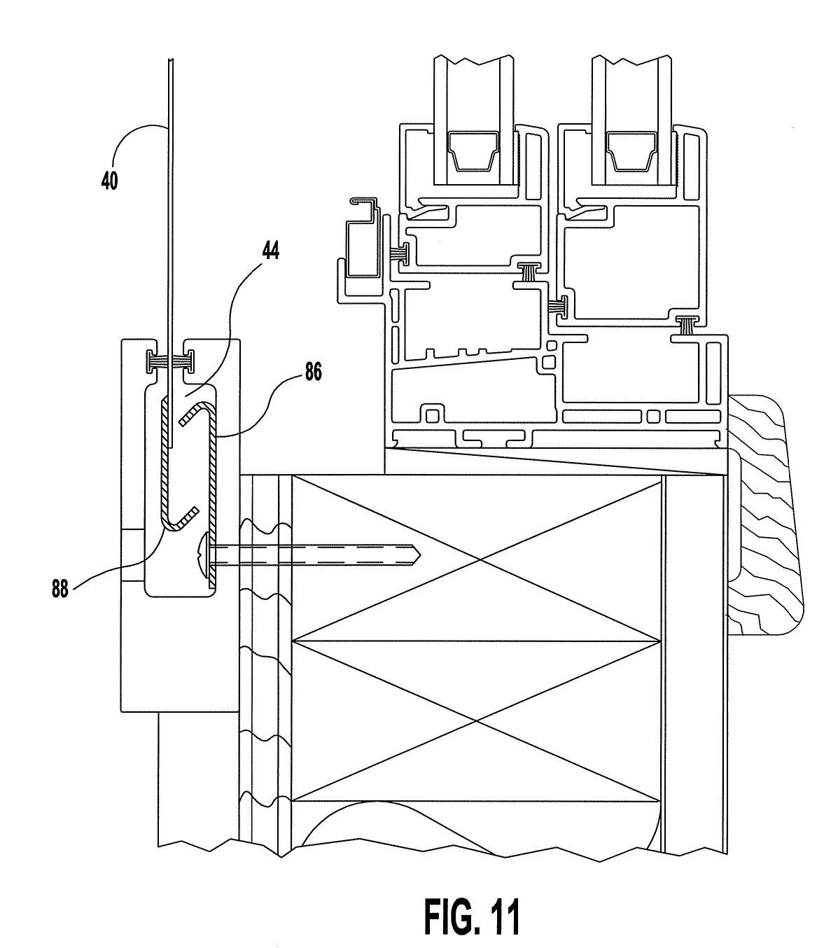

FIG. 11 shows still another alternative first and second retention members that can be used to secure the vertical edges of fabric sheet 40 within the fabric track 44 of window casing 42. In the embodiment of FIG. 11, the first retention member is a hook 86 that runs continuously through fabric track 44. The second retention member is a plurality of hooks 88 that are secured to the fabric sheet 40. Continuous hook 86 faces oppositely from hooks 88 at times when the fabric sheet is fully extended over the fenestration opening. In this position, the open ends of hooks 86, 88 couple together if fabric sheet 40 is moved in a lateral direction to prevent the edge of fabric sheet 40 from being drawn out of fabric track 44.

As fabric sheet 40 is unwound from spindle 38, hooks 88 enter and then travel through fabric track 44. Because of the orientation of hooks 86, 88, they couple together and engage each other so that hooks 88 cannot pass laterally out of fabric track 44 and are retained therein.

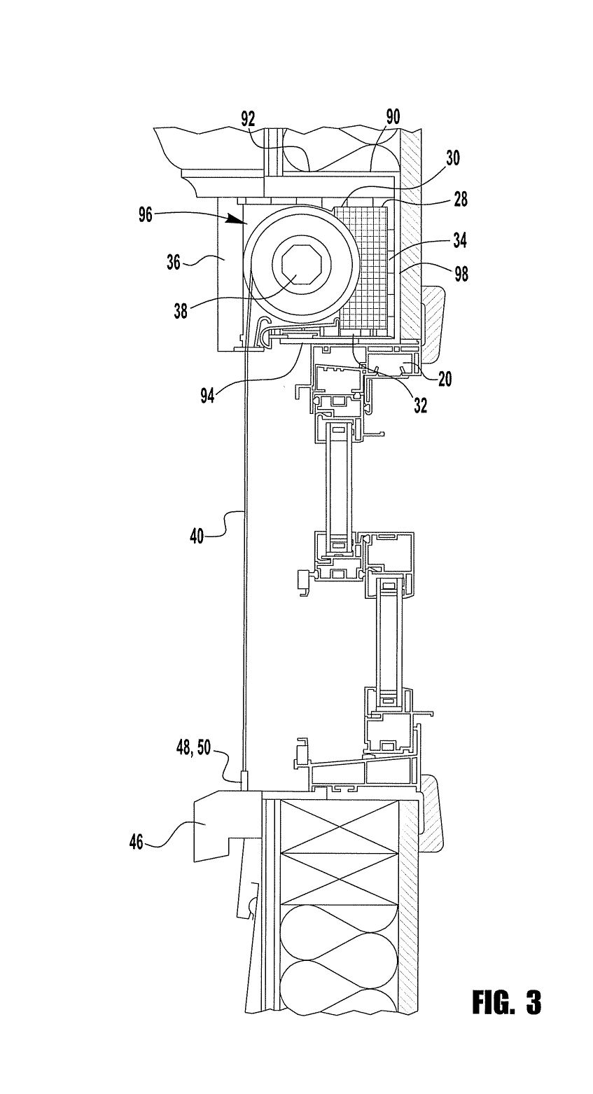

FIG. 3 shows another embodiment of the invention disclosed herein wherein the use of an alternative building header allows the use of a larger window for a given building opening. The embodiment of FIG. 3 is similar to the embodiment of FIGS. 1 and 2 wherein like elements are designated with the same reference numbers. However, in the embodiment of FIG. 3, the building frame header is a steel header 90 that is used in place of the conventional wood frame header 10 shown in FIG. 1. Steel header 90 includes a top portion 92 and a bottom portion 94. Top portion 92 is spaced apart from bottom portion 94 so that top portion 92 and bottom portion 94 define a space 96 therebetween.

The fenestration header 20 of fenestration frame 18 is secured to bottom portion 94 of steel header 90. Box 28 is located in space 96 between top portion 92 and bottom portion 94. This arrangement effectively locates box 28 within the top boundary of the building opening and allows more space for the window. Thus, for a given building opening, the embodiment of FIG. 3 will allow more space for the window and permit the use a larger size window.

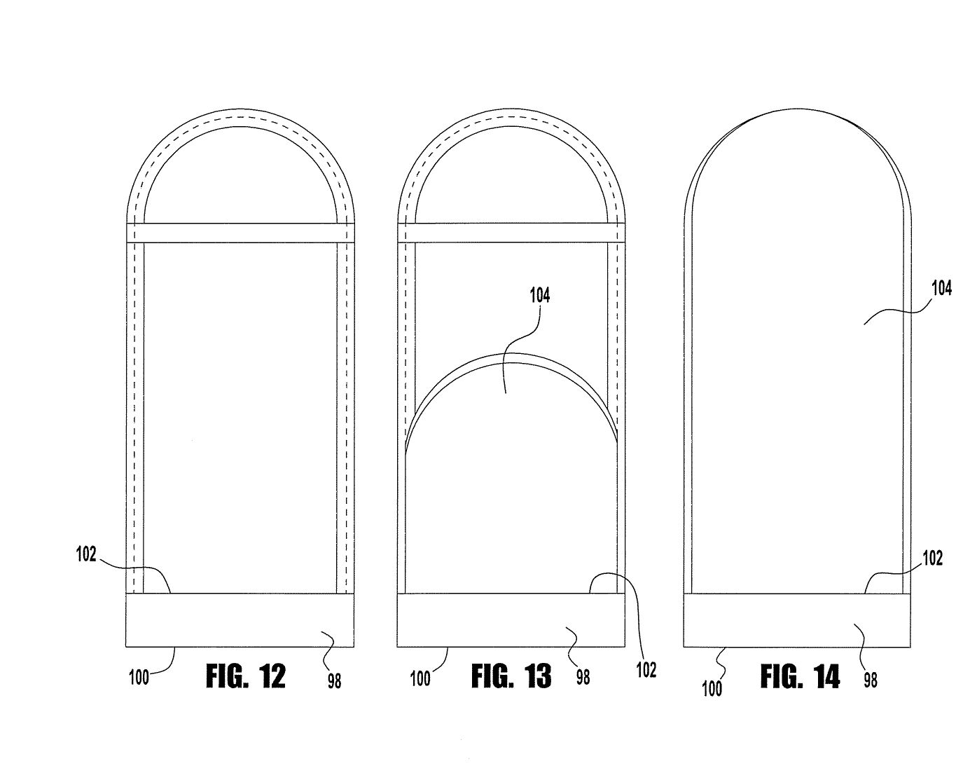

Another embodiment of the disclosed invention is shown in FIGS. 12, 13 and 14 wherein elements that are common to the elements of FIGS. 1 and 2 are given the same reference numbers. The embodiment of FIGS. 12, 13 and 14 overcomes the difficulty of using a roller shutter with a fenestration member that has a curved top. As shown in FIGS. 12, 13 and 14, a roller shutter box 98 is located at the bottom of the window. Roller shutter box 98 is similar to the roller shutter box 28 that is shown and described in connection with FIGS. 1, 2 and 3. Roller shutter box 98 includes a spindle that is rotatably mounted therein. A fabric sheet 104 is attached to the spindle at or near one edge of fabric sheet 104. Fabric sheet 104 coils around the spindle in response to the angular rotation of the spindle. In response to rotation of the spindle in roller shutter box 98, the fabric sheet 104 is extended upwardly and retracted downwardly to cover the fenestration member such as a window or door.

The free end of fabric sheet 104 is shaped in correspondence with the curved top of the fenestration member. FIG. 12 shows the roller shutter box with fabric sheet 104 fully retracted. FIG. 13 shows the roller shutter box with fabric sheet 104 partially extended. FIG. 14 shows the roller shutter box 98 with the fabric sheet 104 fully extended. Similar to the structure of FIGS. 1 and 2, roller shutter box 98 can be located between the fenestration frame and the building frame. Alternatively, similar to the structure of FIG. 3, to allow a larger window for a given building opening, roller shutter box 98 can be included in a building sill in which the top portion and bottom portion of the building sill define a space therebetween and the roller shutter box is located in the space between the top and bottom portions.

FIG. 14A shows a roller shutter box that is located at the top of a curved-top window. Trim panels 105 are located between the curved top 105a and the roller shutter box 28. In this embodiment, the roller shutter can be used with the curved top window in the same fashion as the rectangular windows shown in FIGS. 1 and 2.

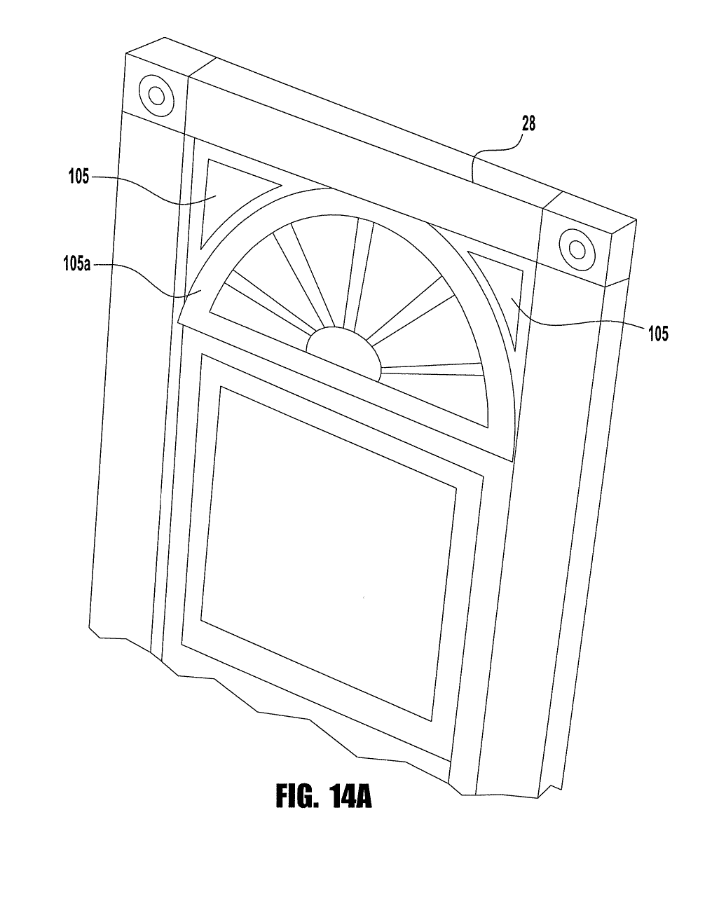

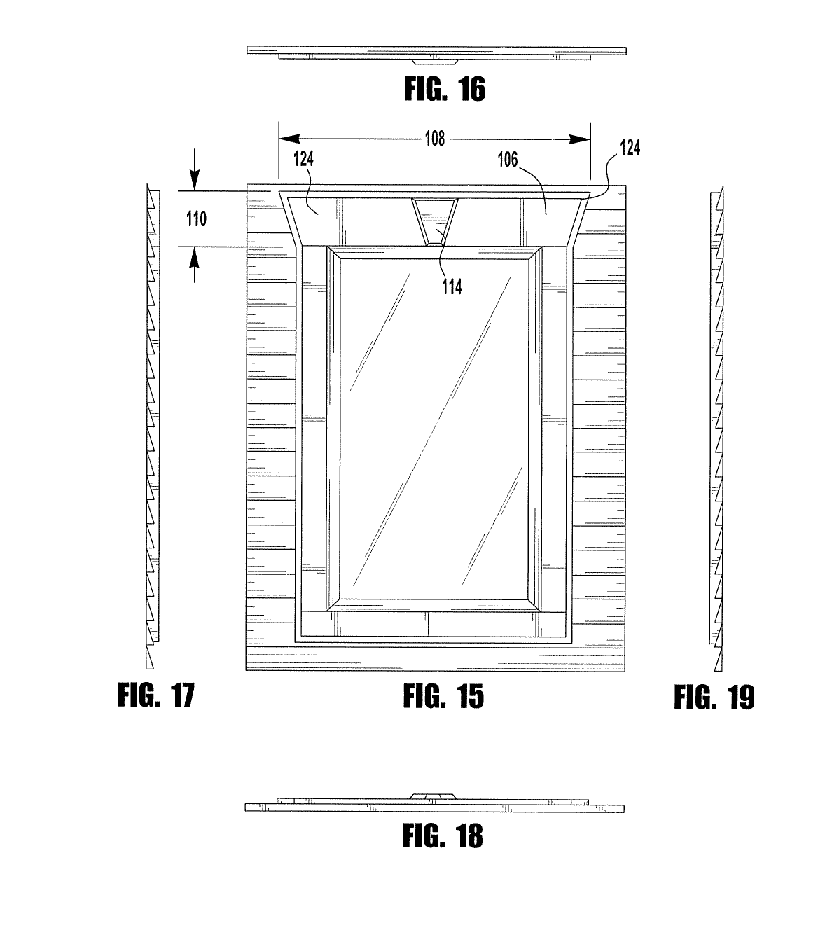

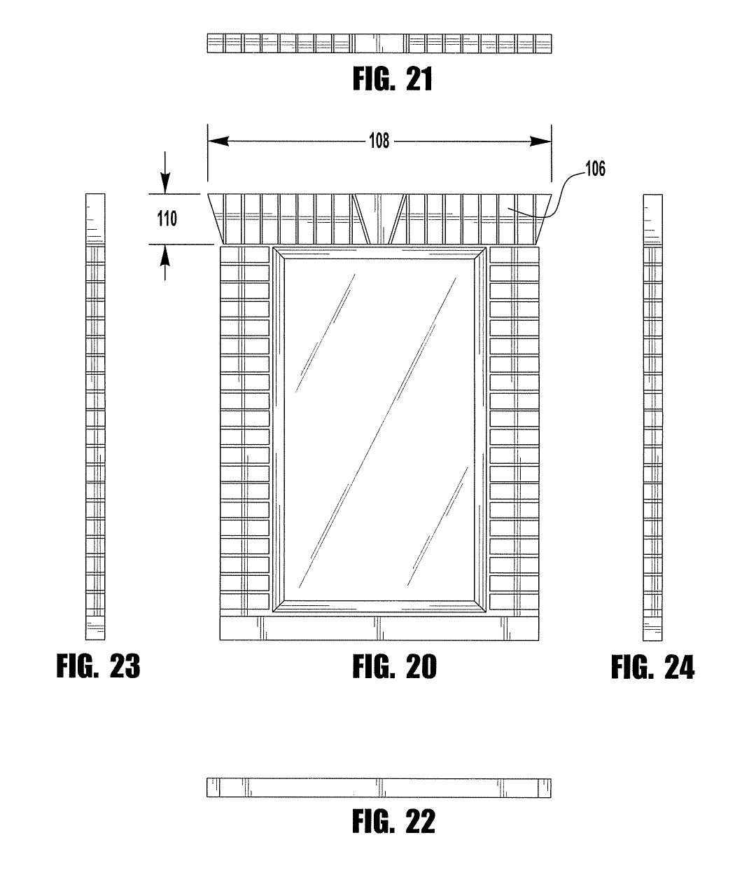

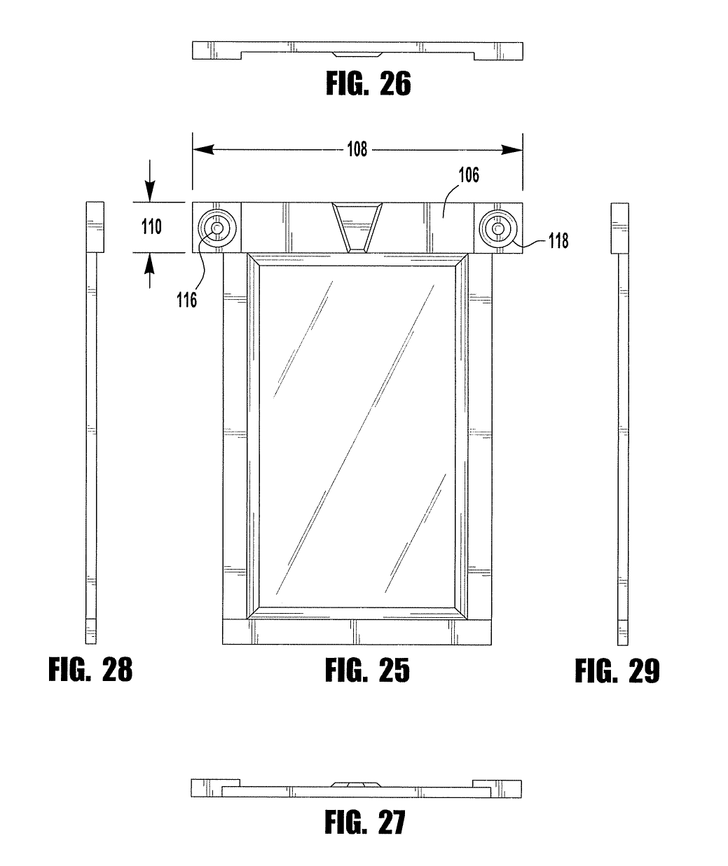

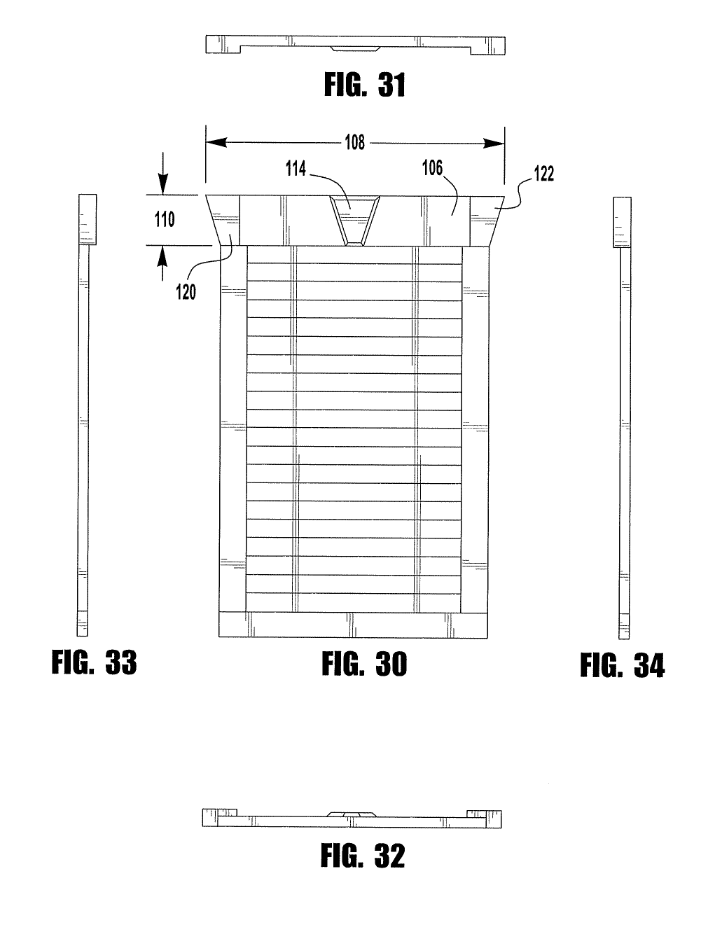

FIGS. 15-34 show examples of a roller shutter whereon traditional trim features are incorporated in design of the shutter box. In FIGS. 15-34, the exterior cover of box 28 is in the shape of various crossheads 106 that are arranged on the outside of said building. Crossheads 106 have a length dimension 108 that is greater than the width dimension 110. Crossheads 106 are oriented so that the length of the crosshead is substantially parallel to the length of the exterior cover 36 of roller shutter box 28.

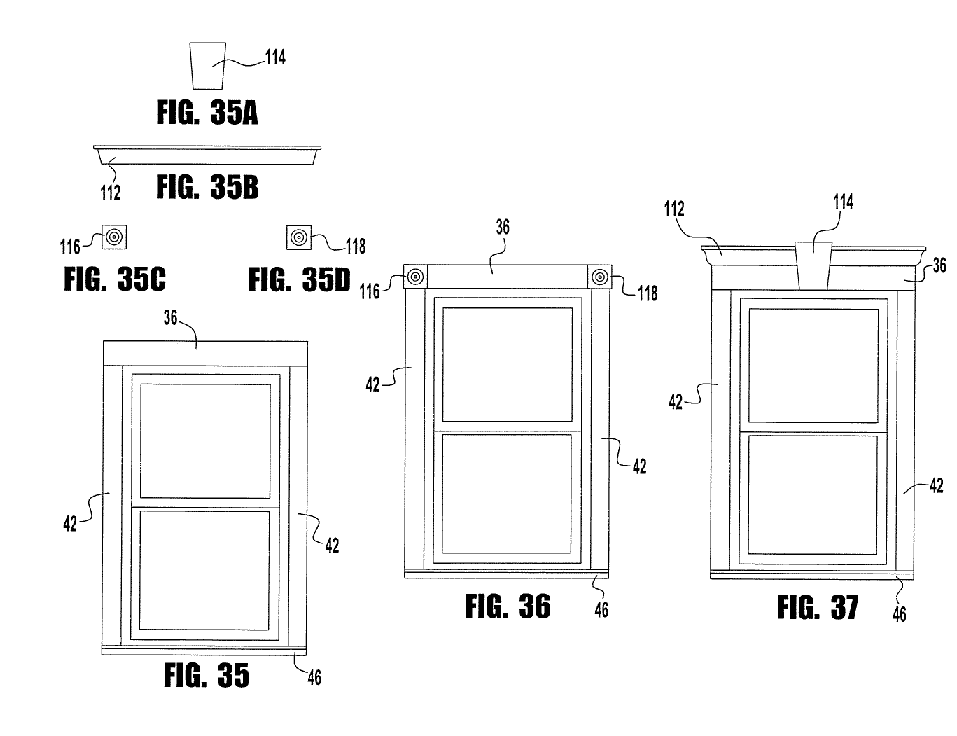

FIGS. 35A-35D show traditional casing trim that can be added to the roller shutter's cover 36, screen tracks 42 and sill trim 46.

FIGS. 35-37 show examples of a window that incorporates the roller shutter disclosed herein and wherein the traditional casing trim of FIGS. 35A-35D can be used to improve the aesthetics of the roller shutter. FIG. 35 shows a window that includes screen tracks 42 and a cover 36 as shown in FIGS. 1 and 2. As shown in FIGS. 36 and 37, various trim components can be added to cover 36 for aesthetic purposes. FIG. 37 shows a crosshead trim piece 112 that can be combined with a keystone trim piece 114. FIG. 36 shows a pair of rosettes 116, 118 that are added to the window.

Many types and styles of trim components other than those specifically shown in FIGS. 35-37 can be applied to fenestration members in the manner generally illustrated in FIGS. 35-37. For example, FIG. 30 shows a keystone trim piece 114 in combination with two corner trapezoids 120, 122. As another example, FIG. 15 shows a keystone trim piece 114 with a crosshead 106 wherein corner trapezoids 124 are integrally formed in crosshead 106.

Such trim components are designed to be interchangeable so that they can be added in many combinations to improve the appearance of the fenestration member by adding various designs and details of the trim. For example, rosettes 116, 118 and corner trapezoids 120, 122 are designed to attach to crosshead trim piece 112 by essentially the same coupling mechanism such that corner trapezoids 120, 122 could be substituted for rosettes 116, 118 on the same crosshead trim piece 112. In addition to a variety of shapes and designs, such trim components can be made to have various surface textures or colors so as to further increase the number of possible combinations and further improve the appearance of the fenestration member.

While several presently preferred embodiments of the invention have been shown and described herein, the presently disclosed invention is not limited thereto but can be otherwise variously embodied within the scope of the following claims.

We claim:

1. A roller shutter for use in covering a fenestration member that is secured in an opening in a building, said building opening being defined by a building frame header, a building frame sill, a first building frame riser that is connected to a first end of said building frame header and to a first end of said building frame sill, and a second building frame riser that is connected to a second end of said building frame header and a second end of said building frame sill, said roller shutter assembly comprising:
a fenestration frame having;
a fenestration header,
a fenestration sill that is secured to the building frame sill,
a first fenestration vertical riser that is secured to a first end of said fenestration header and to a first end of said fenestration sill, said first fenestration riser also being secured to the first building riser, and
a second fenestration vertical riser that is secured to a second end of said fenestration header and to a second end of said fenestration sill, said second fenestration riser also being secured to the second building riser;
a box that is located between the building frame header and the fenestration header;
a spindle that is rotatably mounted in said box; and
a fabric sheet that is attached to said spindle adjacent one edge of said fabric sheet, said fabric sheet coiling around said spindle in response to the rotation of said spindle in one angular direction and uncoiling from said spindle in response to the rotation of said spindle in the opposite angular direction, said fabric sheet being extended and retracted over said fenestration member in accordance with the angular position of said spindle.

2. The roller shutter of claim 1 wherein said fabric sheet comprises an aramid fiber composite that is woven into fabric.

3. The roller shutter of claim 1 or 2 further comprising a window casing that is secured to the external wall of the building at the perimeter of the building opening, said casing defining a fabric track that confines an edge of the fabric sheet at times when the spindle is angularly positioned so that the fabric sheet at least partially covers the fenestration member.

4. The roller shutter of claim 1 or 2 wherein said fabric track includes a first retention member and wherein said fabric sheet includes a second retention member that engages the first retention member to retain one edge of the fabric sheet at times when the spindle is angularly positioned such that the fabric sheet at least partially covers the fenestration member.

5. The roller shutter of claim 1 or 2 wherein said fabric track includes a first retention member and wherein said fabric sheet includes a second retention member that engages the first retention member to retain one edge of the fabric sheet within the fabric track at times when the spindle is angularly positioned such that the fabric sheet at least partially covers the fenestration member and the first retention member is vertically aligned with the second retention member.

6. The roller shutter of claim 5 wherein said first retention member includes a pin that is movable and wherein aid second retention member is a hole in the fabric sheet that is engaged by said pin.

7. The roller shutter of claim 5 wherein said first retention member comprises one of a bead material or a receptor that is complementary shaped to receive said bead material, and wherein the second retention member is the other of said bead material or receptor that is complementary-shaped to receive said bead material.

8. The roller shutter of claim 5 wherein said first retention member comprises a first hook and wherein the second retention member comprises a second hook that is complementary-positioned to engage said first hook.

9. The roller shutter of claim 5 wherein aid first retention member comprises a button, having a width dimension and wherein said second retention member comprises a channel segment that defines a gap that is narrower than the width of said button.

10. The roller shutter of claim 1 further comprising:
a cover that cooperates with said box to cover the portion of said fabric sheet that is coiled on said spindle.

11. The roller shutter of claim 10 wherein the length dimension of said cover is greater than the width dimension of said cover, and wherein said roller shutter further includes a crosshead that is arranged on the outside of said building, said crosshead having a length dimension that is greater than its width dimension, said crosshead being oriented so that the length of said crosshead is parallel to the length of said cover.

12. The roller shutter of claim 1, or 2 further comprising at least one trim component that is secured to said box for aesthetic display.

13. The roller shutter of claim 12 wherein said at least one trim component is selected from a group of trim components, the members of said group of trim components being interchangeable with each other.

14. The roller shutter of claim 12 wherein said at least one trim component is selected from a group of trim components, the members of said group of trim components having different surface textures or different colors.

15. A roller shutter for use in covering a fenestration opening in a building, said roller shutter comprising:
a building frame header that has a top portion and bottom portion, with the top portion of said building frame header being spaced apart from the bottom portion of said header such that said top portion and said bottom portion define a space therebetween;
a fenestration frame having a fenestration header that is secured to the bottom portion of said building frame header;
a box that is located in the space defined between the top portion and the bottom portion of said building frame header;
a spindle that is rotatably mounted in said box and that is angularly rotatable therein; and
a fabric sheet that is attached to said spindle, said fabric sheet being attached to said spindle near an edge of said fabric sheet, said fabric sheet coiling around said spindle in response to the angular rotation of said spindle in one direction and that uncoils from said spindle in response to the angular rotation of said spindle in the opposition direction; said fabric sheet being extended and retracted over the opening of said building frame in response to rotation of said spindle.

16. The roller shutter of claim 15 wherein a portion of said box is received between the top portion and the bottom portion of said building frame header, and wherein another portion of said box extends from between the top portion and the bottom portion of said building frame header.

17. The roller shutter of claim 16 wherein said building frame header is comprised of metal.

18. The roller shutter of claim 17 wherein said building frame header is comprised of steel.

19. The roller shutter of claim 15 or 16 wherein said building opening further comprises:
a building frame sill;
a first building frame riser that is connected to a first end of said building frame header and to a first end of said building frame sill; and
a second building frame riser that is connected to a second end of said building frame header and to a second end of said building frame sill.

20. The roller shutter of claim 19, wherein said fenestration frame further comprises;
a fenestration sill that is secured to the building frame sill,
a first fenestration vertical riser that is connected to a first end of said fenestration header and to a first end of said fenestration sill, said first fenestration riser being secured to the first building riser; and
a second fenestration vertical riser that is connected to a second end of said fenestration header and to a second end of said fenestration sill, said second fenestration riser being secured to the second building riser.

21. The roller shutter of claim 15, or 16 wherein said fabric sheet comprises an aramid fiber composite that is woven into fabric.

22. The roller shutter of claim 15 or 16 further comprising a window casing that is secured to the external wall of the building at the perimeter of the building opening, said casing defining a fabric track that confines an edge of the fabric sheet at times when the spindle is angularly positioned so that the fabric sheet at least partially covers the fenestration member.

23. The roller shutter of claim 15 or 16 wherein said fabric track includes a first retention member and wherein said fabric sheet includes a second retention member that engages the first retention member to retain one edge of the fabric sheet at times when the spindle is angularly positioned such that the fabric sheet at least partially covers the fenestration member.

24. The roller shutter of claim 15 or 16 wherein said fabric track includes a first retention member and wherein said fabric sheet includes a second retention member that engages the first retention member to retain one edge of the fabric sheet within the fabric track at times when the spindle is angularly positioned such that the fabric sheet at least partially covers the fenestration member and the first retention member is vertically aligned with the second retention member.

25. The roller shutter of claim 15 or 16 wherein said first retention member includes a pin that is movable and wherein said second retention member is a hole in the fabric sheet that is engaged by said pin.

26. The roller shutter of claim 25 wherein said first retention member comprises one of a bead material or a receptor that is complementary-shaped to receive said bead material, and wherein the second retention member is the other of said bead material or receptor that is complementary-shaped to receive said bead material.

27. The roller shutter of claim 25 wherein said first retention member comprises a first hook and wherein the second retention member comprises a second hook that is complementary-positioned to engage said first hook.

28. The roller shutter of claim 25 wherein aid first retention member comprises a button having a width dimension and wherein said second retention member comprises a channel segment that defines a gap that is narrower than the width of said button.

29. The roller shutter of claim 15 further comprising:
a cover that cooperates with said box to cover the portion of said fabric sheet that is coiled on said spindle.

30. The roller shutter of claim 29 wherein the length dimension of said cover is greater than the width dimension of said cover, and wherein said roller shutter further includes a crosshead that is arranged on the outside of said building, said crosshead having a length dimension that is greater than its width dimension, said crosshead being oriented so that the length of said crosshead is substantially parallel to the length of said cover.

31. The roller shutter of claim 15 or 16 further comprising at least one trim component that is secured to said box for aesthetic display.

32. The roller shutter of claim 31 wherein said at least one trim component is selected from a group of trim components, the members of said group of trim components being interchangeable with each other.

33. The roller shutter of claim 31 wherein said at least one trim component is selected from a group of trim components, the members of said group of trim components having different surface textures or different colors.

34. A roller shutter assembly for use in covering a fenestration opening in a building, said fenestration opening having a curved header, said roller shutter assembly comprising:
a building frame sill that has a top portion and bottom portion, with the top portion of said sill being spaced apart from the bottom portion of said sill such that said top portion and said bottom portion define a space therebetween;
a fenestration frame having a fenestration sill that is secured to the top portion of said building frame sill;
a box that is located in the space defined between the top portion and the bottom portion of said building frame sill;
a spindle that is rotatably mounted in said box and that is angularly rotatable therein; and
a fabric sheet that is attached to said spindle, said fabric sheet being attached to said spindle near an edge of said fabric sheet, said fabric sheet coiling around said spindle in response to the angular rotation of said spindle in one direction and that uncoils from said spindle in response to the angular rotation of said spindle in the opposite direction; said fabric sheet being extended upwardly and retracted downwardly over the opening of said building frame in response to rotation of said spindle.
